(19) United States
(12) Patent Application Publication
(10) Pub. No.: US 2003/0129087 A1
(43) Pub. Date: Jul. 10, 2003

(54) Ordered adsorbed layers of nano particulate materials on structured nano-laminate templates

(75) Inventors: Troy W. Barbee JR., Palo Alto, CA (US); William D. Wilson, Pleasanton, CA (US)

Correspondence Address: Alan H. Thompson, Assistant Laboratory Counsel, Lawrence Livermore National Laboratory, L-703, P.O. Box 808, Livermore, CA, 94551, US

(73) Assignee: The Regents of the University of California

(21) Appl. No.: 10/167,926

(22) Filed: Jun. 11, 2002

Related U.S. Application Data
(60) Provisional application No. 60/298,601, filed on Jun. 13, 2001.

(51) Int. Cl. G01N 27/00

(52) U.S. Cl. 422/58; 422/68.1; 422/82.01

(57) ABSTRACT

Structural nano-laminate templates to collect and organize atoms, molecules, nano-crystals, colloids, cells, proteins, and spores. The nanostructured materials enables controlled deposition of molecules and nanoparticles, and in many applications, enable attachment of organic or “soft” matter to an inorganic or “hard” substrate. This enables the deposition of proteins onto specific site or into ordered arrays which can facilitate their detection as well as their crystallization. The nano-laminates may be constructed using magnetron sputtering to deposit alternating layers of selected materials, such as amorphous alumina and amorphous silica, on a silicon substrate. The substrate is then sectioned and polished, exposing the cross-sections of the deposited layers, and to which selected proteins, for example, are attached in an ordered manner.

### RELATED APPLICATION

This application relates to U.S. Provisional Application No. 60/298,601 filed Jun. 13, 2001, and claims priority thereof.

The United States Government has rights in this invention pursuant to Contract No. W-7405-ENG-48 between the United States Department of Energy and the University of California for the operation of Lawrence Livermore National Laboratory.

### BACKGROUND OF THE INVENTION

The present invention relates to chemical sensors, particularly to sensors using nano-laminate template, and more particularly to a sensors which involve ordered adsorbed layers of nano particulate materials, such a proteins, on structured nano-laminate templates.

The ability to collect and organize atoms, molecules, nanocrystals, colloids, cells, proteins, and spores on a substrate is a major goal of nano-science and technology and has enormous potential in the fields of material science, synthetic chemistry, biology and medicine, as well as national security. There has been a problem in developing a technology in which the structural scale of a template can be engineered by man to match the scale of a nano body and thereby manipulate it to form an ordered structure or to selectively absorb the nano body enabling assay and analysis. This has been addressed using standard lithographic approaches in the past that cannot, at this time, achieve nano dimensions over significant areas in the range less than 70 nm.

The crystallization of proteins is the rate-limiting step in determining their structure and hence function. While the use of surfaces to mediate nucleation events is well utilized in metal and semiconductor crystal growth, its use in protein epitaxy is hampered by the lack of available surfaces with lattices commensurate with protein sizes.

There is a limited regime of supersaturations that create diffraction quality protein crystals. Low supersaturations lead to long nucleation times and high supersaturations produce many small crystals. Much effort has gone into combinatorial methods to find optimal crystallization conditions. Typically, vapor grown crystals do not have these problems because they start with a template. It has been appreciated that protein epitaxy could solve many of the protein crystallization problems but there are few materials with periodicities commensurate with typical protein dimensions (2-15 nm).

By the present invention, it is established that multilayer structures can be used to order proteins. The multilayers can be easily tuned over a wide range of spacings and materials to create templates to screen a range of protein sizes and chemistries.

Nanolaminates are constructed using magneton sputtering to deposit alternating layers of amorphous alumina and amorphous silica onto a silicon (100) substrate for example. The period can be varied from 1 to >200 nm. The total thickness of the multilayers is typically 5 μm and thus might contain 50 alumina-silica pairs with periods of 10 nm. Also, multilayers with thicknesses greater than 200 μm have been fabricated for specific applications. The periods are measured using both TEM and XRD for a subset of the samples. Sections of the wafers were then mounted in epoxy and polished, exposing their cross-sections. Several nanolaminates are mounted in the same epoxy puck allowing samples with different periods to be subjected to the same experimental conditions. Alumina and silica were chosen because they have opposite surface charges in solution near neutral pH.

To test the ability of nanolaminate to order, one would chose a protein which was both smaller and larger than the multilayer periods in the mounted cross-section array. The enzyme A transcarbomylase (ATCase) is a large protein with a 12 nm diameter. To deposit the protein, a droplet of dilute ATCase in Tris buffer would be placed on the nanolaminate substrate and allowed to interact with the surface for approximately 10 minutes prior to rinsing with millipure water and blowing dry with N₂ gas. A control without the protein can be placed on the other end of the sample and subjected to the same conditions.

This approach demonstrates the potential of this technological methodology and provides guidance as to optimization of experimental conditions which will result in protein crystal nucleation.

### SUMMARY OF THE INVENTION

It is an object of the present invention to provide a chemical sensor using nano-laminate structures.

A further object of the invention is to provide structured nano-laminate templates to obtain ordered adsorbed layers of nano particulate materials.

Another object of the invention is to provide nano-laiminate material cross-sections as templates for ordered absorption of proteins.

Another object of the invention is to provide nanostructured materials for controlled deposition of molecules and nanoparticles, and, in many applications, attachment of organic or “soft” matter to an inorganic or “hard” substrate.

Another object of the invention is to enable the deposition of proteins onto specific site or into ordered arrays which can facilitate their detection as well as their crystallization.

Another object of the invention is to provide nano-laminates composed of oxide/oxide, oxide/metal, and metal/metal.

Other objects and advantages of the present invention will become apparent from the following description and accompany drawing. The present invention provides ordered adsorbed layers of nano particles, such as proteins, on structured nano-laminate templates. The templates are cross-sections of nano-laminate materials which enable ordered absorption of proteins, for example. The nano-laminate materials may be oxide/oxide, oxide/metal, and metal/metal.

This invention enables the assessment of the viability of the nano-laminate template approach to the development of chemical sensors for pesticides and other toxic molecules such as dioxin. Such sensors, for example, might involve binding the hydrophobic component of a protein to a dimensionally appropriate hydrocarbon (e.g., a thioalkane on gold) region bound to a nano-laminate layer. The receptor binding site, specific to a given target molecule, resides on the hydrophilic component of this same protein. The nano-laminate in this case provides a tailor-made artificial membrane to which the specific protein is tethered.

Nano-laminate structures may also enable dimensionally commensurate multiple binding sites to be engineered—a major factor in overcoming non-specific binding. A virus sensor capable of highly specific recognition of two sites could be designed. Protein A (e.g., GP120) which binds to site 1 on a virus (e.g. HIV) is tethered using thiols as a coupling agent to an ˜10 Å gold layer; Protein B is similarly attached to an adjacent (˜100 Å separation) gold layer. When protein A binds to site 1, it activates site 2 on this same GP120 protein, enabling the binding of protein B to site 2. In the case of HIV, the ˜100 Å separation between active sites is reduced to ˜40 Å following multiple binding.

Toxins such as botulinum and anthrax of interest to biowarfare also bind to multiple sites on a cell membrane. Gangliosides, specific to each toxin, might be attached to one ˜10 Å gold layer while protein A, known to bind to a second site on the toxin would be attached to an adjacent layer, separated by an engineered distance (˜50 Å) clearly within the control of nano-laminate technology. The ganglioside holds the toxin molecule at one site long enough for protein A to bind to the other site, thus providing the specificity. Optical fluorescence techniques as well as impedance spectroscopy may make possible recognition of this multiple-binding event and thus the activity state of such toxins.

### BRIEF DESCRIPTION OF THE DRAWINGS

The accompanying drawings which are incorporated into and form a part of the disclosure, illustrate embodiments of the invention and, together with the description, serve to explain the principles of the invention.

FIGS. 1A, 1B and 1C are enlarged cross-section high resolution transmission electron microscopy (TEM) images of three oxides/oxide nano-laminate structures.

FIGS. 2A, 2B and 2C are schematic illustrations of configurations of the nano-laminate structures, with FIG. 2A being an oxide/oxide, FIG. 2B being a metal/oxide, and FIG. 2C being a metal/oxide backed with a conducting substrate.

FIGS. 3A and 3B are atomic force microscope (AFM) images of nano-laminate surfaces, with FIG. 3A emphasizing step edges, and FIG. 3B emphasizing differences in surface charge and material by control.

FIGS. 4A, 4B, and 4C are AFM images of alumina-silica nano-laminates with periods ranging from 10 nm to 200 nm, wherein the material pairs of FIG. 4A is 5 nm SiO₂-5 nmAl₂O₃, of FIG. 4B is 13 nmSiO₂-31 nmAl₂O₃, and of FIG. 4C being 100 nm SiO₂-100 nmAl₂O₃, with each image being taken in tapping mode using a carbon nanotube tip.

FIGS. 5A, 5B and 5C illustrate, via AFM images, that nano-laminates can be used to impart order on adsorbing collide, with FIG. 5A being alumina-silica with a 20 nm period, FIG. 5B being the same nano-laminate with a protein, ATCase (˜12 nm diameter) adsorbed preferentially onto the silica layer, and FIG. 5C showing the protein adsorbed onto a silicon substrate as having short-range hexagonal packing that differs considerably from the ordering on the nano-laminate sections.

FIG. 6 illustrates cross-section electron micrographs of YZr—Al₂O₃ equal layer thickness thermal barrier coating structures with five(5) different nano-laminate periods.

FIG. 7 illustrates a TEM cross-section of a metal-oxide nano-laminate.

FIGS. 8A, 8B, and 8C illustrate how the substrate period affects the ordering of the protein.

FIGS. 9A and 9B illustrate that diffusion enhances ordering in hard spheres.

FIG. 10 illustrates a 78 Å/32 Å (Al₂O₃/SiO₂) period nanolaminate which produces three layers of protein growth and in plane protein ordering.

### DETAILED DESCRIPTION OF THE INVENTION

The present invention involves ordered adsorbed layers of nano particulate materials, such as proteins, on structured nano-laminate cross-section templates. This invention provides the ability to collect and organize atoms, molecules, nanocrystals, colloids, proteins and spores on a substrate is a major goal of nano-science and technology and has enormous potential in the fields materials science, synthetic chemistry, biology and medicine and national security. Achieving this goal requires development of nanostructured materials for controlled deposition of molecules and nanoparticles, and, in many applications, attachment of organic or “soft” matter to an inorganic or “hard” substrate. The deposition of proteins onto specific site or into ordered arrays can facilitate their detection as well as their crystallization, the latter being a necessary step in structure determination an daunting task for the field of Proteomics. Such engineered or controlled protein adsorption is an example of nano-organization.

This invention has the potential to enable creation of new approaches protein structural determinations crucial in the developing field of Proteomics as well opening the technical door to new techniques for development of ordered or samples with controlled disorder for scientific study and technological application.

This invention will enable the assessment of the viability of this approach to the development of chemical sensors for pesticides and other toxic molecules such as dioxin. Such sensors, for example, might involve binding the hydrophobic component of a protein to a dimensionally appropriate hydrocarbon (e.g., a thioalkane on gold) region of a nano-laminate. The receptor binding site, specific to a given target molecule, resides on the hydrophilic component of this same protein. The nano-laminate in this case provides a tailor-made artificial membrane to which the specific protein is tethered.

Nano-laminate structures may also enable dimensionally commensurate multiple binding sites to be engineered—a major factor in overcoming non-specific binding. A virus sensor capable of highly specific recognition of two sites could be designed. Protein A (e.g., GP120) which binds to site 1 on a virus (e.g. HIV) is tethered using thiols as a coupling agent to an ˜10 Å gold layer; Protein B is similarly attached to an adjacent (˜100 Å separation) gold layer. When protein A binds to site 1, it activates site 2 on this same GP120 protein, enabling the binding of protein B to site 2. In the case of HIV, the ˜100 Å separation between active sites is reduced to ˜40 Å following multiple binding.

Toxins such as botulinum and anthrax of interest to biowarfare also bind to multiple sites on a cell membrane. Gangliosides, specific to each toxin, might be attached to one ˜10 Å gold layer while protein A, known to bind to a second site on the toxin would be attached to an adjacent layer, separated by an engineered distance (˜50 Å) clearly within the control of nano-laminate technology. The ganglioside holds the toxin molecule at one site long enough for protein A to bind to the other site, thus providing the specificity. Optical fluorescence techniques as well as impedance spectroscopy may make possible recognition of this multiple-binding event and thus the activity state of such toxins.

Nano-laminates are constructed using magnetron sputtering to deposit alternating layers of amorphous alumina and amorphous silica, for example, onto a silicon (100) substrate for example. The period can be varied from 1 to >200 nm. The total thickness of the multilayers is typically 5 μm and thus might contain 50 alumina-silica pairs with periods of 10 μm. Multilayer structures having thicknesses greater than 200 μm have been fabricated for specific applications. The periods are measured using both TEM and XRD for a subset of the samples. Sections of the wafers were then mounted in epoxy and polished, exposing their cross-sections. Several nano-laminates are mounted in the same epoxy puck allowing samples with different periods to be subjected to the same experimental conditions. Alumnina and silica were chosen because they have opposite surface charges in solution near neutral pH.

To test the ability of the nano-laminate to order, one would chose a protein which has both smaller and larger multilayer periods. The enzyme A transcarbomylace (ATCase) is a large protein with a 12 nm diameter. To deposit the protein, a droplet of dilute ATCase in Tris buffer would be placed on the nano-laminate substrate and allowed to interact with the surface for approximately 10 minutes prior to rinsing with millipure water and blowing dry with N₂ gas. A control without the protein can be placed on the other end of the sample and subjected to the same conditions.

Nano-laminate materials are a new class of materials for technological application. At this time, nano-laminate structures have been synthesized by PVD in elemental form, as alloys, or a compounds—from at least 82 of the 92 naturally occurring elements. The microstructure scale of these materials is determined during synthesis by controlling the thickness of the individual layers. These layers are from one monolayer (0.2 nm) to hundreds of monolayers (>500 nm) thick and, except in special cases, generally define the in-depth crystalline grain size. The in-plane grain sizes are generally 2 or 3 times the layer thickness. It is important to note that atom-by-atom synthesis processes typically produce highly textured layers with the close-packed lattice plane of the layer materials in the plane of the multilayer, though these grains are randomly oriented in plane. Recently, processes for mulitple source magnetron sputter deposition of thick, macroscopic nano-laminate materials have been developed at LLNL and have been used to fabricate free-standing high-quality structures >0.3 mm (300 μm) thick containing up to 50,000 individual layers. This research synthesis system produce samples have periods uniform to 5% and areas of up to 7000 cm².

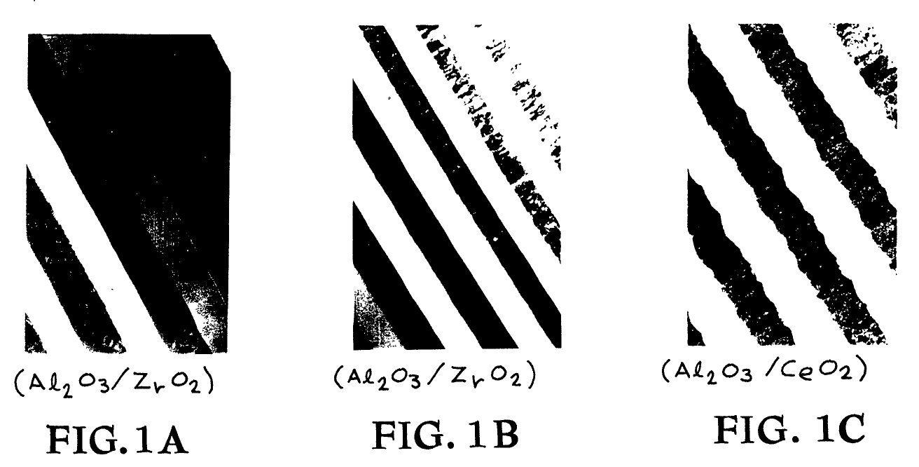

In this invention, the nano-laminates are cross-sectioned, making the spatial and compositional nature of their structure accessible for interaction with biological/chemical species. Transmission electron micrographs of three 30 μm thick oxide nano-laminate cross-sections are shown in FIGS. 1A and 1B. The Al₂O₃ in these samples is amorphous. The ZrO₂ and YZrO₂ in FIGS. 1A and 1B are initially amorphous or extremely fine grained, developing a crystalline phase as the layer thickness increases. The CeO₂ in FIG. 3 is crystalline. The zero-point charge (ZPC) values for these oxides, as conventional known, are ≈9.3 for Al₂O₃ and ≈7.9 for ZrO₂, showing that surface potential differences can be developed on the nano scale that will be determinative in any cation or anion absorption reactions. The three nano-laminate structures of FIGS. 1A, 1B, and 1C include 100 nm Al₂O₃ with 100 nm of ZrO₂, YZrO₂, and CeO₂ respectively, with a d≈2000 Å period.

If silicon dioxide is used as one layer in an Al₂O₃/SiO₂ structure its zero point charge of ≈3 will, when correlated with the of Al₂O₃ result in a very large potential structure on the exposed nano-laminate section. It will be possible through control of solution pH to selectively absorb a specie on one of the layers in a nano-laminate layer relative to the other.

As already discussed, the control of structural scale and composition makes this simple phenomenon very powerful as a result of the commensurate dimensionality with respect to biological molecules and chemical species that can be achieved. Application of this effect may make possible the design of nano-laminates as templates for initiation of protein crystallization. For example, a nano-structure consisting of many ˜1 nm gold layers separated by specified distance (˜5 nm) could be employed as an initiation layer for protein orientation. Control of fluid pH and interlayer spacing might enable the growth of protein crystals, a vital step in the determination of protein crystal structures for the proteomics effort. Scanned probe microscopies, optical spectroscopies, electrical absorption or loss spectroscopies may all be investigated as diagnostics for the phenomena developed in the interaction of biological/chemical species with exposed nano-laminate cross-section surfaces.

Fabrication of Nanostructured Surfaces

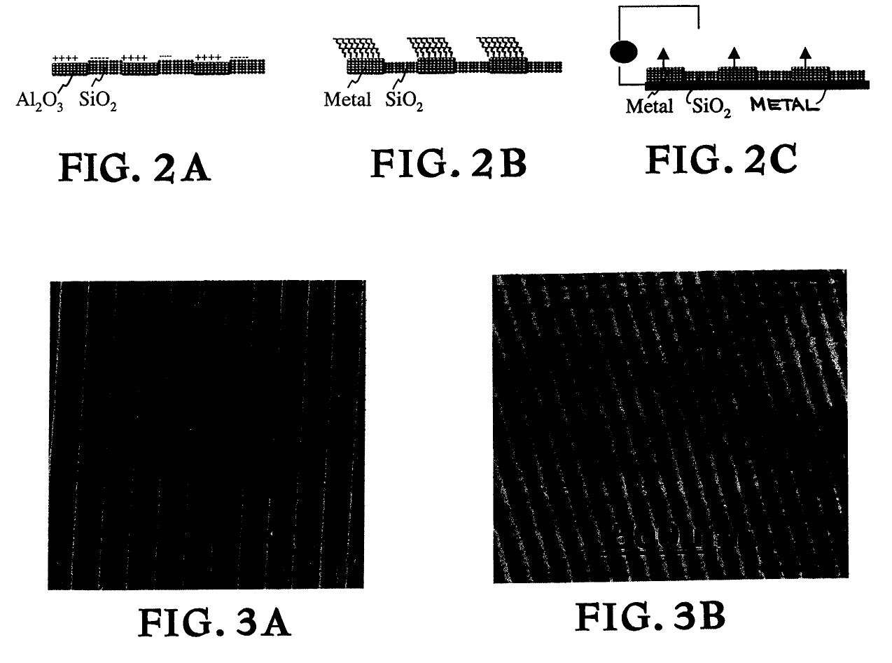

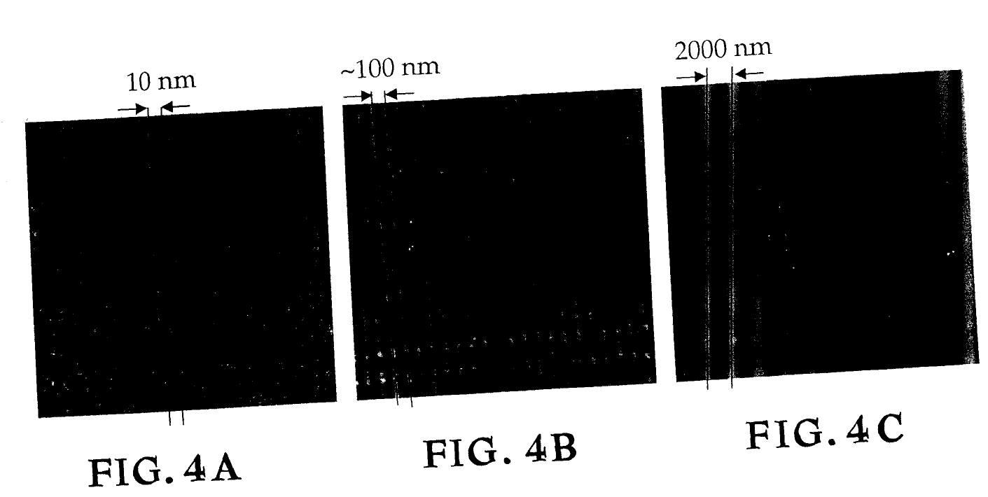

Nanolaminates: Nanolaminate materials are ultrafine grained, low contamination multi-layer solids with high interface concentration. Though the most visible of such materials are semiconductor superlattices synthesized using molecular beam epitaxy (MBE) techniques and structures intended for x-ray optic applications, multilayers have been synthesized by physical vapor deposition from more than 75 of the 92 naturally occurring elements in elemental form, as alloys or as compounds. Individual layer thicknesses of >1 nm have been achieved and thicknesses larger than 200 μm can be made with several materials. We have fabricated metal-oxide, oxide-oxide and metal-metal nano-laminate structures. A schematic example of some potential nanolaminate structures is shown in FIGS. 2A-2C and AFM images of nanolaminates are given in FIGS. 3A-3B and 4A, 4B and 4C.

FIGS. 2A, 2B, and 2C are schematic illustrations of various configurations of nano-laminate samples. In FIG. 2A, oxide-oxide nanolaminates have a surface charge corrugation when placed in neutral buffer due to the different isoelectric points of alumina and silica. In FIG. 2B, the metal-oxide nanolaminates can be functionalized taking advantage of flexible thiol chemistry. In FIG. 2C, the metal-oxide nanolaminates can be backed with a conducting substrate that allows an external potential to be applied relative to a standard electrode placed in the fluid cell.

With reference to FIGS. 3A-3B, the AFM images of nano-laminate surfaces illustrate in FIG. 3A the height image of Al₂O₃/SiO₂-100 nm/100 nm emphasizes step edges, and in FIG. 3B, the friction image of Al₂O₃/SiO₂-40 nm/40 nm where contrast emphasizes differences in surface charge resulting from the nano-laminate imposed spatial variation in isoelectric points.

Magnetron sputter deposition characteristics of materials in elemental, alloy or inter-metallic forms vary widely. Therefore, engineering calibration of process parameters for the range of materials to be used must be defined by experiment. Important process characteristics include: 1) layer thickness; 2) layer thickness uniformity throughout a sample; 3) layer composition; 4) fabrication process reproducibility; 5) process stability in a long deposition experiment; and 6) process flexibility. Thus, a systematic approach to the development of a nano-laminate magnetron sputter deposition process is needed if the structural and fabrication process characteristics outlined above are to be reproducibly achieved. The use of magnetron sputter deposition sources and DC electrical power supplies, the linear and reproducible dependence on the sputter rate on the sputter source excitation power, and stable motion control leads to fine control over nano-laminate fabrication as illustrated in FIGS. 3A and 3B.

When nanolaminates are placed in electrolyte solutions, the alternating composition of cross-sectioned 1 nm to 200 nm period multilayers modulates the near surface potential through the material specific double layers formed at the solid/fluid interface. Because it is the electric field due to the surface charges which should ultimately be responsible for driving the ordering of adsorbates, the demonstrated technical ability to create macroscopic nano-laminate materials with controlled dimensionalities commensurate with scales characteristic of supramolecular, colloidal and biological species creates broad possibilities for creation of both new, nanostructured materials and a flexible test-bed for simulations.

Nano-laminates have been fabricated of alumina/silica, ceria/alumina, zirconia/alumina, and yttria-stabilized zirconia/alumina with various periodicities by reactive sputter deposition. AFM data show that polishing relief of cross-sections of these samples is limited to what we believe to be the lowest level measured for coupons of this type and material combinations. The reproducible achievement of this nano level polishing relief is critical to the application of these nano-laminates as templates for applications involving deposition and ordering.

Because the surface charge depends on the isoelectric point of a material and the solution pH, the attraction of the AFM tip to the surface should also depend on the solution pH. Indeed, we have found that friction image contrast (FIGS. 4A, 4B and 4C) changes with pH. Thus, to obtain a measure of the charge variation across a nanolaminate, we can use friction mapping where the contrast now represents a variation in charge distribution.

FIGS. 4A, 4B and 4C show atomic force microscope (AFM) images of alumina-silica nano-laminates with periods ranging from 10 nm to 200 nm. The material pairs are (FIG. 4A) 5 nmSiO₂-5 nmAl₂O₃, (FIG. 4B) 13 nmSiO₂-31 nm Al₂O₃, and (FIG. 4C) 100 nm SiO₂-100 nmAl₂O₃. All images were taken in tapping mode using a nanotube tip. The images are (FIG. 4A) 300 nm×300 nm, phase contrast, (FIG. 4B) 1 μm×1 μm topographic contrast, and (FIG. 4C) 2 μm×2 μm topographic contrast.

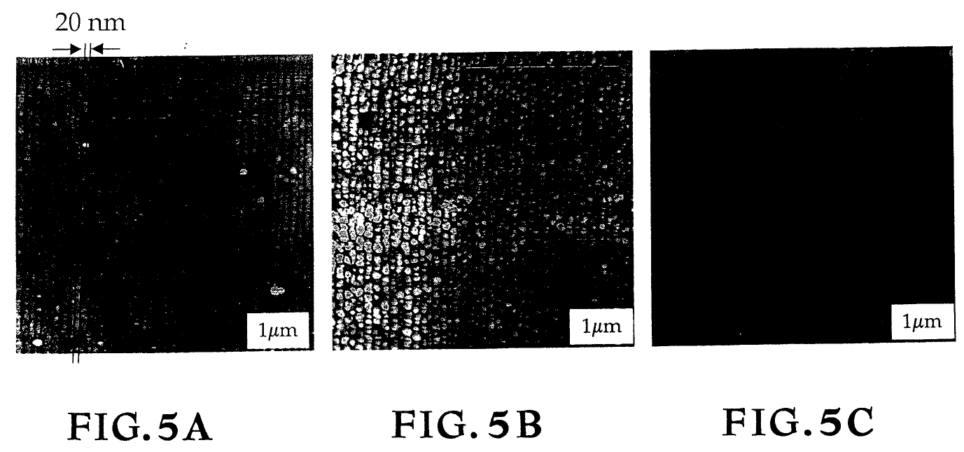

In a test for the induction of order by a nano-laminate substrate, the nano-laminate was dipped into a supersaturated solution of the protein ATCase. (˜12 nm diameter). The substrate was then rinsed and imaged dry using a carbon nanotube tip for improved resolution (FIGS. 5A-5C). FIG. 5A shows a section with the nanolaminate structure before deposition of protein. FIG. 5B shows the protein adsorbed onto the nanolaminate. The protein is deposited preferentially on the silica layers and ordering is clearly seen. A plain silicon section of the substrate was imaged as the control (FIG. 5C). This last image shows that the adsorbed may protein exhibit short-range order but no long range order and the packing geometry is dramatically different than on the nanolaminate. This image shows linear ordering along the nano-laminate and discrete areas with 2D ordering suggestive of crystallization.

As shown in FIGS. 5A-5C, nano-laminates can be used to impart order on adsorbing colloids. The AFM image of FIG. 5A shows an alumina-silica nano-laminate with a 20 nm period, FIG. 5B shows the same nano-laminate with the protein, ATCase (˜12 nm diameter) adsorbed preferentially onto the silica, and FIG. 5C shows the protein adsorbed onto the silicon substrate as having short-range hexagonal packing that differs considerably from the ordering on the nano-laminated section (FIGS. 5A-5B), with all images being 1 μm×1 μm.

The Fourier transform of this image shows discrete spots similar to a simulated structure. A plain silicon section of the substrate was imaged as the control (FIG. 5C). This image shows that the adsorbed protein exhibits only short range order and the packing geometry is dramatically different than on the nano-laminate.

These results indicate that this will enable the assessment of the viability of this approach to the development of chemical sensors for pesticides and other toxic molecules such as dioxin. Such sensors, for example, might involve binding the hydrophobic component of a protein to a dimensionally appropriate hydrocarbon (e.g., a thioalkane on gold) region of a nano-laminate. The receptor binding site, specific to a given target molecule, resides on the hydrophilic component of this same protein. The nano-laminate in this case provides a tailor-made artificial membrane to which the specific protein is tethered.

Nano-laminate structures may also enable dimensionally commensurate multiple binding sites to be engineered—a major factor in overcoming non-specific binding. A virus sensor capable of highly specific recognition of two sites could be designed. Protein A (e.g., GP120) which binds to site 1 on a virus (e.g. HIV) is tethered using thiols as a coupling agent to an ˜10 Å gold layer; Protein B is similarly attached to an adjacent (˜100 Å separation) gold layer. When protein A binds to site 1, it activates site 2 on this same GP120 protein, enabling the binding of protein B to site 2. In the case of HIV, the ˜100 Å separation between active sites is reduced to ˜40 Å following multiple binding.

Toxins such as botulinum and anthrax of interest to biowarfare also bind to multiple sites on a cell membrane. Gangliosides, specific to each toxin, might be attached to one ˜10 Å gold layer while protein A, known to bind to a second site on the toxin would be attached to an adjacent layer, separated by an engineered distance (˜50 Å) clearly within the control of nano-laminate technology. The ganglioside holds the toxin molecule at one site long enough for protein A to bind to the other site, thus providing the specificity. Optical fluorescence techniques as well as impedance spectroscopy may make possible recognition of this multiple-binding event and thus the activity state of such toxins.

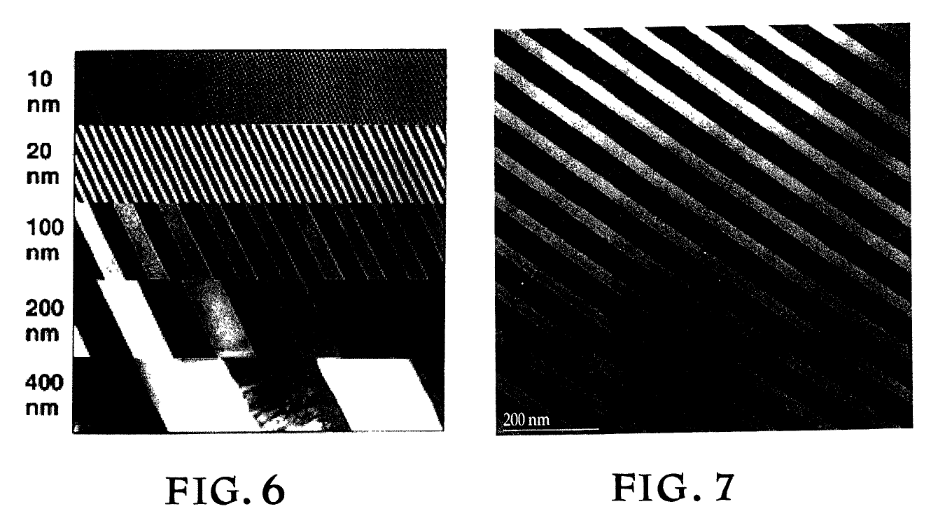

FIG. 6 illustrates an advanced performance multilayer thermal barrier coating. The engineered composition and microstructure decreased thermal conductivity by factors of 2 to 5, and increased the thrust-to-weight ratio. As shown, a YZr—Al₂O₃ thermal barrier coating structure is illustrated by electron micrographs of cross-sections composed from top to bottom of 10 nm, 20 nm, 100 nm, 200 nm, and 400 nm.

FIG. 7 illustrates by TEM a metal-oxide (Monel 400/SiO₂) nano-laminate cross-section. The Monel 400 layers are higher contrast due to both electron absorption and diffraction.

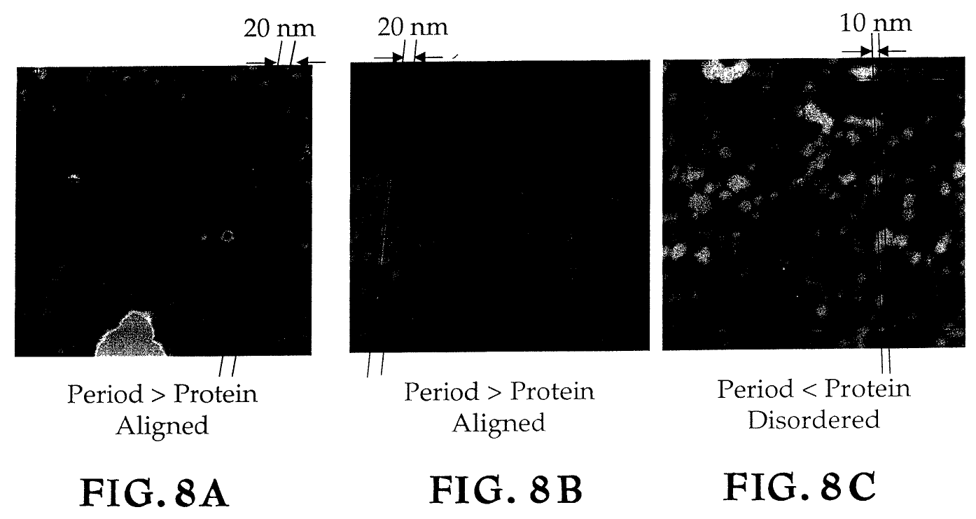

The substrate period affects the ordering of the protein, as shown in FIGS. 8A, 8B, and 8C, with the period>Protein aligned in FIGS. 8A and 8B, and the Period<Protein disordered in FIG. 8C.

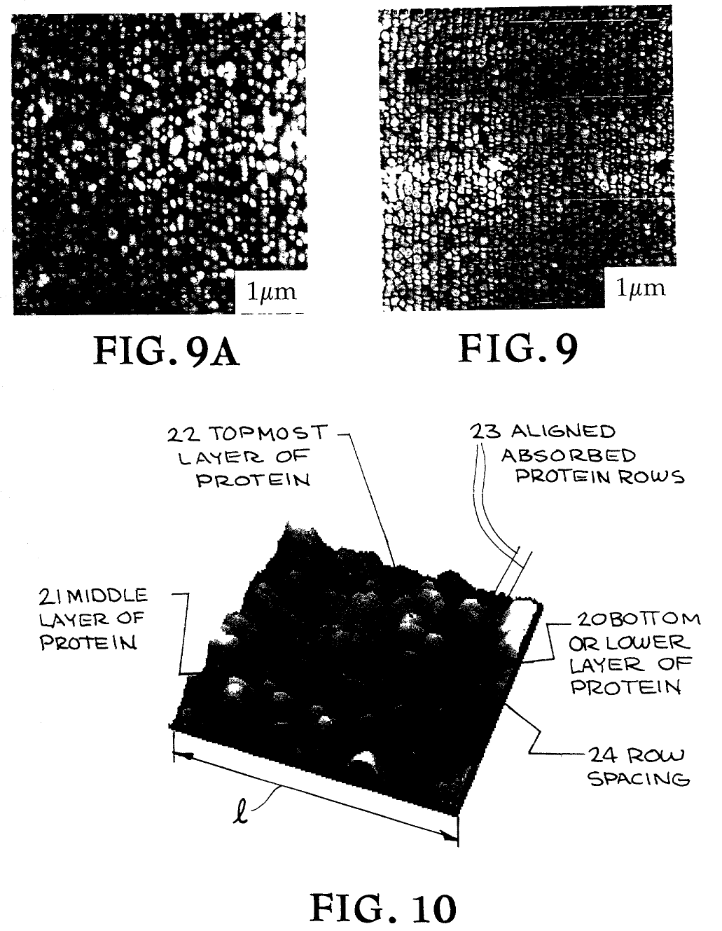

High coverage suggests that diffusion enhances ordering, as shown in FIGS. 9A and 9B, wherein ballistic deposition produces <70% coverage for hard spheres.

FIG. 10 illustrates an AFM image that a 78 Å/32 Å (Al₂O₃/SiO₂) period nano-laminate produces three layers of growth, a lower layer or lines of protein indicated by arrow 20, a middle layer or protein indicated by arrow 21, and a topmost layer of protein indicated by arrow 22. Three characteristics are seen in FIG. 10. First, rows of aligned absorbed protein indicated at 23 of approximately 11 nm diameter are absorbed along the nano-laminate layers in the first or bottom layer 20. Adjacent row ordering is also demonstrated. Second, a second layer is seen and is apparent from AFM height sensitivity. Local near layer ordering is seen in this second or middle layer 21. Third, a layer is also observed in which the individual proteins were not imaged. As shown, row spacing indicated at 24 is equal to 107 to 112 Å. FIG. 10 has a length(l) of 2500 Å. Al₂O₃/SiO₂: period nano-laminate of 110 Å which corresponds to the row spacing 24 of 107-112 Å.

Although the template structures focussed on thus far are produced from macroscopic nano-laminate material samples other fabrication approaches will be available in future. These include the gamut of lithographic technologies developed for and applied in integrated circuit manufacture. In addition, new classes of such lithographic technologies are being developed that will facilitate structures with definition at the 10 nm to 30 nm level over surface areas required for integrated circuit fabrication. These are based on beam writing using laser light, electron beams and scanning probes.

It has thus been shown that the invention provides nano-laminate material cross-sections as templates for ordered absorption of proteins or other nano-particulate materials. The deposition of proteins onto specific site or into ordered arrays can facilitate their detection as well as their crystallization. The nano-laminate cross-sections may be oxide/oxide, oxide/metal, metal/metal, metal/alloy, alloy/oxide, metal/nitride, metal/carbide, nitride/nitride, and carbide/carbide. By way of example, Monel 400, referenced above is an alloy of 70% Ni/30% Cu with an oxide of SiO₂ (an alloy/oxide). A metal/nitride may be Pt/TcN, a metal/carbide being Cu/Cr₃C₂, a nitride/nitride being HfN/TcN, and a carbide/carbide being Wc/ZrC. Thus, the nano-laminate composition is essentially unlimited.

Heterogeneous template surfaces are made from magnetron-sputter-deposition nano-laminates that are cut across the layers and polished. The layers acquire different surface charges in water, giving a striped charge distribution. Selecting the proper materials (e.g., alumina and silica) and pH, produces alternating positive and negative charges. The resulting pH-dependent electrostatic fields are imaged by AFM.

While particular embodiment have been illustrated and/or described, along with materials, parameters, etc. to exemplify and teach the principles of the invention, such are not intended to be limiting. Modifications and changes may become apparent to those skilled in the art, and it is intended that the invention should be limited only by the scope of the appended claims.

What is claimed is:

1. In a sensor, the improvement comprising:
a nano-laminate template,
said nano-laminate having at least one polished, exposed cross-section.

2. The improvement of claim 1, wherein said nano-laminate is composed of material selected from the group consisting of oxide/oxide, oxide/metal, metal/metal, metal/alloy, alloy/oxide, metal/nitride, metal/carbide, nitride/nitride, and carbide/carbide.

3. The improvement of claim 2, additionally including a conducting substrate.

4. The improvement of claim 1, wherein said nano-laminate is composed of alumina-silica.

5. The improvement of claim 4, wherein the alumina-silica nano-laminate has a period in the range of about 1->200 nm.

6. The improvement of claim 5, wherein said alumina-silica nano-laminate is deposited on a silicon substrate.

7. The improvement of claim 6, wherein the nano-laminate has a thickness of about 5 μm, contains about 50 alumina-silica pairs, with periods of about 10 nm.

8. The improvement of claim 1, wherein said nano-laminate is selected from the group consisting of Al₂O₃/ZrO₂, Al₂O₃/Y(ZrO₂), CeO₂/Al₂O₃, Al₂O₃/SiO₂, YZr/Al₂O₃, and Monel 400/SiO₂.

9. The improvement of claim 8, wherein said nano-laminate is composed of 100 nm Al₂O₃ with 100 nm of ZrO₂, Y(ZrO₂), and CeO₂.

10. The improvement of claim 8, wherein said nano-laminate has a cross-section of up to about 200 μm.

11. The improvement of claim 8, wherein the Al₂O₃ is amorphous.

12. The improvement of claim 8, wherein each of the ZrO₂ and Y(ZrO₂) is initially amorphous or extremely fine grained, developing a crystalline phase as the layer thickness increases.

13. The improvement of claim 8, wherein the CeO₂ is crystalline.

14. The improvement of claim 8, wherein the Al₂O₃ and ZrO₂ have a zero-point charge value of 9.3 and 7.9, respectively.

15. The improvement of claim 8, wherein the nano-laminate is Al₂O₃/SiO₂ with zero-point charge values of 9.3 and 3 respectively.

16. The improvement of claim 1, wherein the nano-laminate is oxide/metal with the oxide being SiO₂.

17. The improvement of claim 16, wherein said oxide/metal nano-laminate is backed with a conducting substrate that allows an external potential to be applied to the conducting layers.

18. The improvement of claim 1, wherein said nano-laminate is composed of a number of ˜1 nm gold layer separated by a distance of about 5 nm, and employed as an initiation layer for protein orientation.

19. The improvement of claim 1, wherein said nano-laminate includes individual layer thicknesses of 1 nm to greater than 200 nm.

20. The improvement of claim 1, wherein said nano-laminate has alternating composition cross-sectioned <1 nm to >200 nm period multilayers.

21. The improvement of claim 1, wherein said nano-laminate is composed of magnetron sputtered alumina/silica, ceria/alumina, zirconia/alumina, and ythria-stabilized zironia/alumina.

22. The improvement of claim 22, wherein said nano-laminate is composed of different periods of alternating materials.

23. A means for collecting and organizing proteins including a nano-laminate cross-section for ordered absorption of proteins.

24. The improvement of claim 8, wherein said nano-laminate is composed of YZr—Al₂O₃ having a cross-section selected from the group consisting of 10 nm, 20 nm, 100 nm, 200 nm, and 400 nm.

25. The improvement of claim 8, wherein said nano-laminate is composed of Monel 400/SiO₂.
